(19) United States
(12) Patent Application Publication
(10) Pub. No.: US 2016/0117594 A1
(43) Pub. Date: Apr. 28, 2016

(54) METHOD AND SYSTEM FOR DEVELOPING A VIRTUAL SENSOR FOR DETERMINING A PARAMETER IN A DISTRIBUTED NETWORK

(71) Applicants: Yandy Perez Ramos, Jacksonville, FL (US); Aldo Ferrante, Ponte Vedra, FL (US)

(72) Inventors: Yandy Perez Ramos, Jacksonville, FL (US); Aldo Ferrante, Ponte Vedra, FL (US)

(21) Appl. No.: 14/952,304

(22) Filed: Nov. 25, 2015

Related U.S. Application Data
(63) Continuation-in-part of application No. 14/920,251, filed on Oct. 22, 2015.
(60) Provisional application No. 62/067,222, filed on Oct. 22, 2014.

(51) Int. Cl. G06N 5/04; G06N 99/00

(52) U.S. Cl. CPC G06N 5/04; G06N 99/005

(57) ABSTRACT

Disclosed is a method and system for developing a virtual sensor for determining a parameter from a set of data for performing a specific function in a distributed network. The method includes collecting the set of data from one or more sensing unit, processing the collected set of data, creating a distributed knowledge database containing the pre-processed set of data, determining the parameter based upon the processed set of data in the distributed knowledge database, performing a specific function using the parameter, wherein the virtual sensor selects at least one intelligent agent for performing the specific function in the distributed network.

### FIELD OF THE DISCLOSURE

The field of the present invention relates generally to systems and methods for sensing data using smart virtual sensors. More specifically, the systems and methods relate to a smart virtual sensor capable of collecting and predicting values based upon other collected data.

### BACKGROUND OF THE DISCLOSURE

Physical sensors are widely used in many products, such as modem machines, to measure and monitor physical phenomena, such as temperature, speed, and emissions from motor vehicles. Physical sensors often take direct measurements of the physical phenomena and convert these measurements into measurement data to be further processed by control systems. Although physical sensors take direct measurements of the physical phenomena, physical sensors and associated hardware are often costly and, sometimes, unreliable. Further, when control systems rely on physical sensors to operate properly, a failure of a physical sensor may render such control systems inoperable. For example, the failure of an intake manifold pressure sensor in an engine may result in shutdown of the engine entirely even if the engine itself is still operable.

Usually, the data of physical sensor is analyzed which requires filtering (e.g., specific runs of semiconductor wafer) and possibly transformations of units. Also, the data must be pre-processed using complex algorithms (e.g., virtual sensors) in order to perform a meaningful analysis. Finally, action must be taken based on the data analysis. For example, faults or errors may indicate a malfunctioning equipment or a need to modified a process parameter immediately on the fly during real-time. The action usually occurs too late because the data analysis requires a significant amount of time. Furthermore, updating or creating new virtual sensors requires restarting or reinstalling the software application being run on a manufacturing machine.

However, currently, there does not exist any software and hardware tool that fully integrates the ability to virtually measure parameters (temperature, pressure or the like) using a Distributed Architecture in a wide area network over the internet, intranet or local area network. There is a need for systems and methods which have the ability to provide virtual sensors to retrain, teach and find optimal algorithms to create a distributed knowledge base used for similar devices. Hence, there is a need for a software and hardware tool that fully integrates the ability to virtually measure parameters using a Distributed Architecture.

### SUMMARY OF THE DISCLOSURE

In view of the foregoing disadvantages inherent in the prior-art and the needs as mentioned above, the general purpose of the present disclosure is to provide a system and method for developing a virtual sensor capable of determining a parameter from a set of data in and designed to include all advantages of the prior art and to overcome the drawbacks inherent in the prior art offering some added advantages.

To achieve the above objectives and to fulfill the identified needs, in one aspect, the present invention provides a computer implemented method for developing a virtual sensor for determining a parameter from a set of data, wherein the parameter is used for performing a specific function in a distributed network. The computer implemented method comprising collecting the set of data from one or more sensing unit in the distributed network, processing the collected set of data, creating a distributed knowledge database containing the processed set of data, determining the parameter based upon the processed set of data in the distributed knowledge database; and performing a specific function using the parameter. The said virtual sensor selects at least one intelligent agent for performing the specific function in the distributed network.

In an aspect of the present invention, the virtual sensor comprises a hardware platform module for determining structure of the one or more sensing units.

In an aspect of the present invention, the virtual sensor comprises a retrain module for updating the virtual sensor with new data from the one or more sensing units.

In an aspect of the present invention, the specific function comprises at least one of control function, and automation function.

In another embodiment of the present invention, the set of data includes data such as temperature, pressure, power factor, downtime, quality parameters, and PH.

In an aspect of the present invention, the one or more sensing unit is a physical sensor.

In an aspect of the present invention, the one or more sensing unit is a virtual sensor.

In an aspect of the present invention, the distributed knowledge database is stored on a server.

In an aspect, the present invention provides a system for determining parameter from a set of data, wherein the parameter is used for performing a specific function in a distributed network. The system comprises one or more processors, a memory comprising a virtual sensor and executable by the one or more processors to perform the steps of collecting the set of data from one or more sensing unit in the distributed network, processing the collected set of data, creating a distributed knowledge database containing the processed set of data, determining the parameter based upon the processed set of data in the distributed knowledge database; and performing a specific function using the parameter. The said virtual sensor selects at least one intelligent agent for performing the specific function in the distributed network.

In yet another aspect, the present invention provides a computer program product computer program product comprising executable instructions which, when executed by one or more processors, cause the one or more processors to carry out various steps. The steps are collecting the set of data from one or more sensing unit in the distributed network, processing the collected set of data, creating a distributed knowledge database containing the processed set of data, wherein the distributed knowledge database is shared over the distributed network, determining the parameter based upon the processed set of data in the distributed knowledge database, and performing a specific function using the parameter, wherein the virtual sensor selects at least one intelligent agent for performing the specific function in the distributed network.

This together with the other aspects of the present invention along with the various features of novelty that characterized the present disclosure is pointed out with particularity in claims annexed hereto and forms a part of the present invention. For better understanding of the present disclosure, its operating advantages, and the specified objective attained by its uses, reference should be made to the accompanying descriptive matter in which there are illustrated exemplary embodiments of the present invention.

### BRIEF DESCRIPTION OF THE DRAWINGS

The advantages and features of the present disclosure will become better understood with reference to the following detailed description and claims taken in conjunction with the accompanying drawing, in which:

FIG. 1 illustrates a schematic diagram about the various components in a distributed network, according to various embodiments of the present invention;

FIG. 2 illustrates a schematic diagram with different platforms running the Virtual Server Client, according to various embodiments of the present invention;

FIG. 3 illustrates a flowchart for the method involved in developing the virtual sensor, according to various embodiments of the present invention;

FIG. 4-5 illustrate a schematic diagram of a Virtual Sensor Server module and a Virtual Sensor Client, according to various embodiments of the present invention;

FIG. 6 illustrates a schematic diagram of an example system to provide the Virtual Sensor Server communication with VSCPLC (Virtual Sensor Client for programmable logic controller) and data storage, according to various embodiments of the present invention;

FIG. 7 illustrates a schematic diagram of an example system to provide the Virtual Sensor Client (VSC) for PLC (programmable logic controller), according to various embodiments of the present invention;

FIG. 8 illustrates a schematic diagram with different platforms running the Virtual Server Client, according to various embodiments of the present invention;

FIG. 9 illustrates a schematic diagram with personal computer (PC) running the Virtual Server Client (VSC), according to various embodiments of the present invention;

FIG. 10 illustrates a schematic diagram of an example system to provide the Virtual Sensor Client (VSC) running on computers or embedded systems, according to various embodiments of the present invention;

FIG. 11 illustrates a schematic diagram of an example system to provide the Virtual Sensor Client (VSC) integration on various hardware platform, according to various embodiments of the present invention;

FIG. 12 illustrates a schematic diagram of an open platform communication system, for interaction between hardware and operating system of a computing device, according to various embodiments of the present invention;

FIG. 13 illustrates a schematic view of Virtual Sensor Client on the web, according to various embodiments of the present invention;

FIG. 14 illustrates a schematic view of Virtual Sensor Client on the web with data collection module, according to various embodiments of the present invention; and

FIG. 15 illustrates a schematic diagram of an example system to provide the Virtual Sensor Client (VSC) system integration, according to various embodiments of the present invention.

Like numerals refer to like elements throughout the present disclosure.

### DETAILED DESCRIPTION OF THE DISCLOSURE

The foregoing descriptions of specific embodiments of the present disclosure have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

The terms “a” and “an” herein do not denote a limitation of quantity, but rather denote the presence of at least one of the referenced item.

The terms “having”, “comprising”, “including”, and variations thereof signify the presence of a component.

The term “sensor” refers to a device that measures a physical quantity and converts it into a signal which can be read by an observer or by an instrument.

The term “distributed network” refers to a network of various components in client-server architecture such that the various components are able to share the resources over the network.

The term “Programmable Logic Controller or PLC” refers to electronic device used in many industries to monitor and control building systems and production processes.

The term “embedded system” refers to a computer system with a dedicated function within a larger mechanical or electrical system, often with real-time computing constraints. Such embedded systems control many devices in common use today.

The terms “communication network” and “distributed network” are being used interchangeably throughout the disclosure of the present invention.

The terms “smart virtual sensor” and “virtual sensor” are being used interchangeably throughout the disclosure of the present invention.

The present invention relates to a computer implemented method for developing a virtual sensor. It will be apparent to a person skilled in the art that a “virtual sensor” relates to a sensor which is capable of sensing data even when there is no physical sensor present. The “virtual sensor” can predict or determine information from a given set of data when actual accessing of data is not feasible in a scenario.

The present invention includes a software-hardware Distributed

Architecture to virtually measure parameters using Artificial Intelligence. The present invention includes the capability to virtually measure parameters based on related data for creating a Distributed Knowledge database or Learning System. The present invention is capable of being installed on different devices such as Computers, Mobile Devices,

Programmable Logic Controller and Embedded Platforms. However, this should not be construed as a limitation to the present invention. Accordingly, the present invention is capable of being used on any computing device.

It will be apparent to a person skilled in the art that distributed computing architecture is computing systems in which components are located on networked computers who coordinate their actions by passing messages which means sending a message to a process and relying on the process and the supporting infrastructure to select and invoke the actual code to run.

For proof-of concept, the present invention provides system and method (hereinafter interchangeably called as “virtual sensor” or “system”) for developing a virtual sensor which is capable of sensing or predicting or determining certain parameter from a set of data.

Referring now to the Figures, the present invention provide a smart virtual sensor system which includes a software run on one or more sensing units for e.g. a Computer, Embedded System, Programmable Logic Controller, Server and Mobile Device. Further, the smart virtual sensor system includes a Data collection module which is adapted to retrieve the data set to be used by the smart virtual sensor. Further, the smart virtual sensor system is adapted to retrieves the data set from the one more sensing units.

Further, the smart virtual sensor system performs a Processing on the retrieved data set and format the data in the best way for the system.

In one embodiment, the present smart virtual sensor system includes a Find Best Algorithm Module which is adapted to find the best intelligent agent (Algorithm) to be used in a specific application. The smart virtual sensor system further includes a Select Hardware Platform Module, which determines the structure of the system depending on the platform or one or more sensing unit that is selected. Further, the smart virtual sensor system includes a Manual or Automatic Retrain Module to keep the smart virtual sensor learning from all the new conditions of the one or more sensing unit. Further, the smart virtual sensor system User Interface (Visualization of the Data) shows the data related to one or more sensing unit.

In one embodiment, the smart virtual sensor system includes Data Log Service or a disturbed knowledge database which is adapted to collect and store data set to be used for the smart virtual sensor system from one or more sensing units. The smart virtual sensor system is adapted to get the values for the parameters that are virtually measured from one or more sensing unit, this one or more sensing unit could use a PC (Personal Computer, a Smart computing device, an Embedded platform or a PLC (Programmable Logic Controller).

In another embodiment, the smart virtual sensor system is a software, hardware and combination thereof. Further, the smart virtual sensor system is able to complete the requisite tasks and provide the user with the useful tool to measure value with or without the help of physical sensor. Further, the smart virtual sensor system allows a user to change or adjust any behavior of the tool; it can change how the tool collects the data, the way that it retrains the agents, or the platform that it will use. The smart virtual sensor system can be used in any kind of system or process, as medical field, health care field, industrial field, Commercial field, social field, logistics field, manufacturing field, financial field, and refrigeration field.

In one embodiment, the smart virtual sensor system is adapted to virtually measure any parameter such as, Temperature, Pressure, Power Factor, Quality Parameters, etc. Further, the smart virtual sensor system is capable of producing different devices, as a High Performance Computer with specific task, an embedded device, an industrial device, a medical device, and a PLC module. All the above devices may have a common task of virtually measuring parameters using a Distributed Architecture.

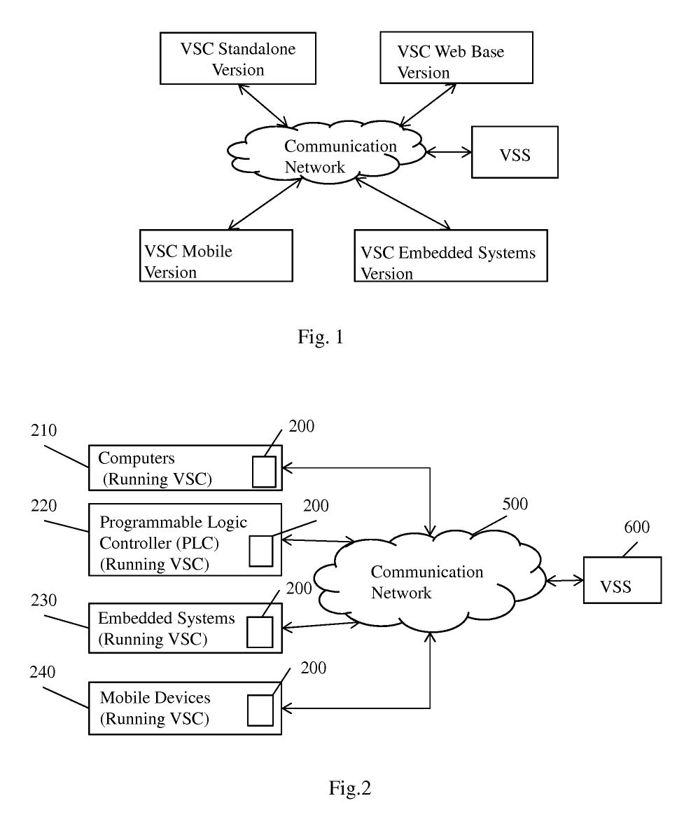

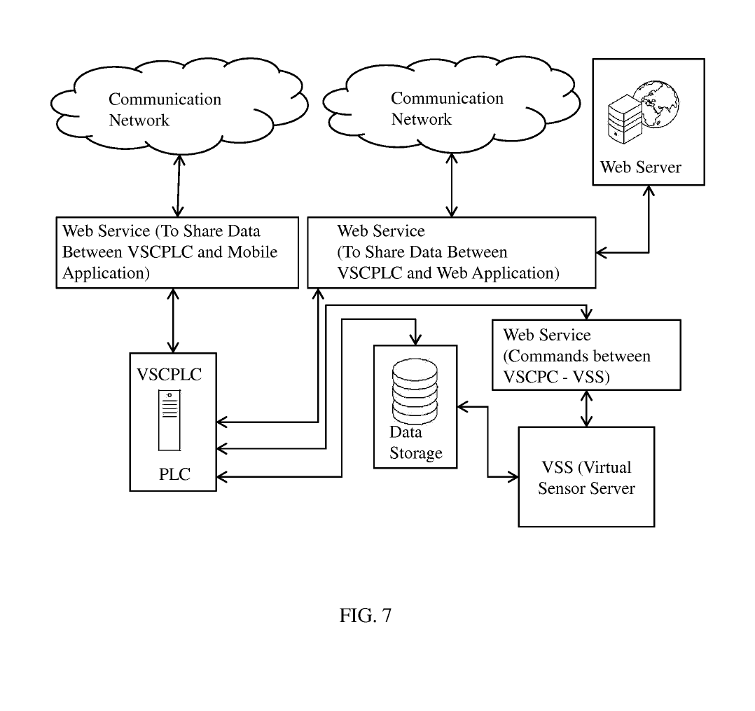

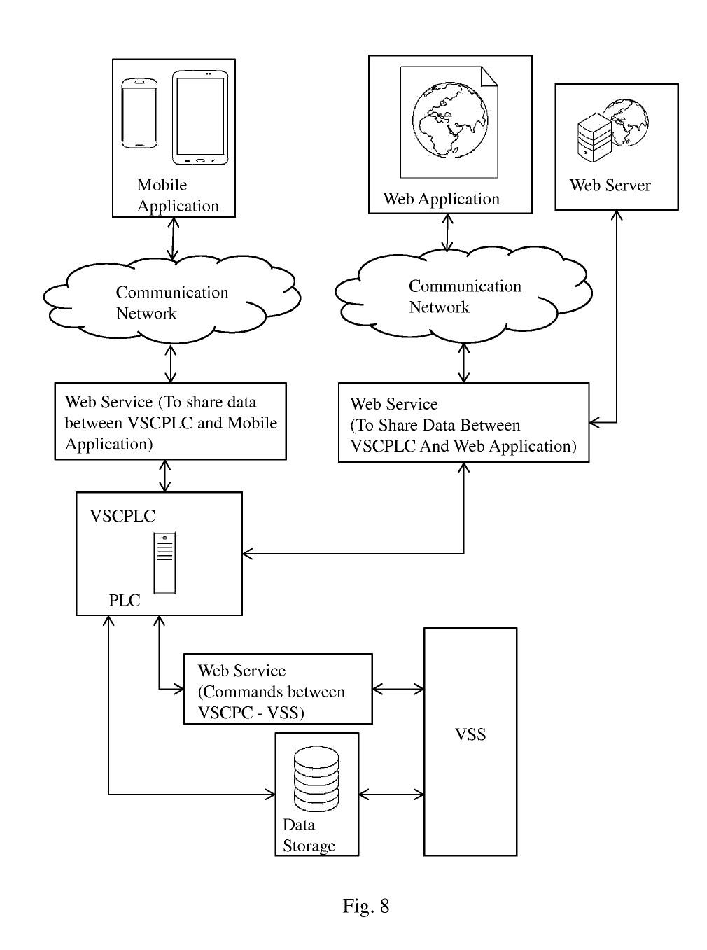

The various embodiments of the present invention shall now be explained in conjunction with FIGS. 1-15.

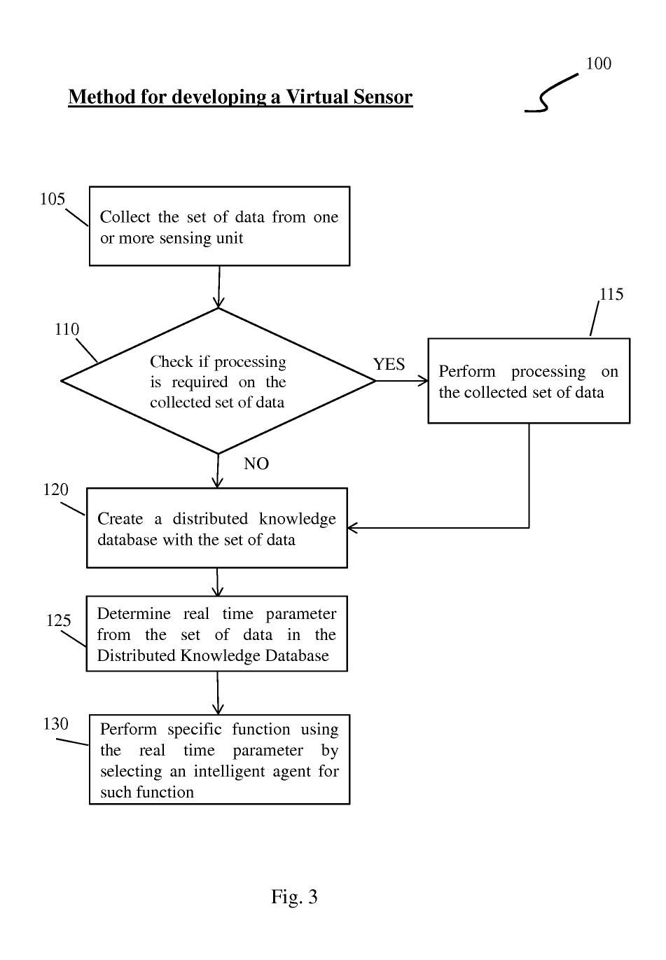

Referring to FIGS. 1 and 2, there are shown schematic design for the functioning of the present invention. FIGS. 1 and 2 illustrate different versions of Virtual Sensor Client (VSC) running on various platforms such as VSC Standalone version, VSC Mobile version, VSC Embedded system and VSC Web base version. Further, there is shown a Virtual Sensor Server (VSS) for communicating with all the versions of Virtual Sensor Client through communication network. Further, FIG. 2 illustrates a computer 210, a programmable logic controller (PLC) 220, an embedded system 230 and a mobile device 240 having a Virtual Sensor Client 200. Further, the Virtual Sensor Client 200 is adapted to communicate with the Virtual Sensor Server 600 via communication network 500 for performing the specific function based on user's requirement. Further, the virtual sensor 200 includes an intelligent agent (not shown) for performing the specific function in the distributed network based on the user's (not shown) requirement.

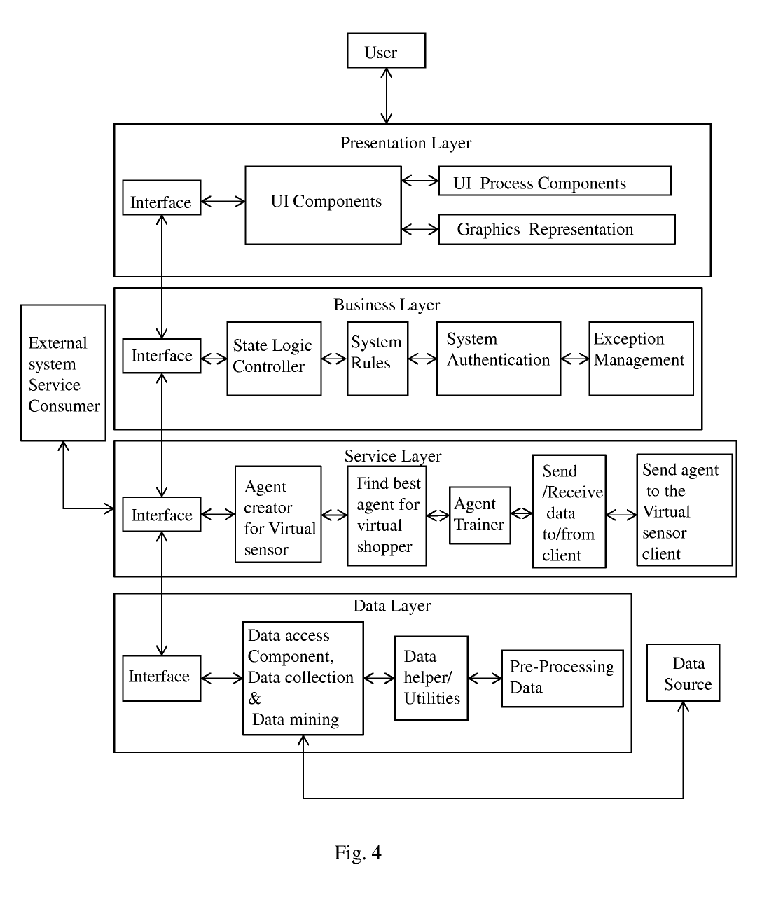

FIG. 3 illustrates a flowchart showing the various steps involved in the method 100 for developing the virtual sensor for determining a parameter from a set of data for performing a specific function in a distributed network. Distributed Architecture relates to the architecture as explained with reference to FIGS. 1 & 2. The method 100 is capable of being installed on a computing device but not limited to a desktop, laptop, Programmable Logic Control, Embedded device, smart device, such as, a tablet and smart phone. The method 100 is capable of being installed as an application on a smart device such as a smart phone.

In an embodiment, the method 100 is accessible by a computing device using a web browser such as the Internet explorer, Google chrome, and others. In another way, the method 100 can be accessed via the web browser using the internet, extranet, intranet, host server, internet cloud and the like.

In an embodiment, the method 100 is capable of being integrated with the ability to virtually measure parameters using Artificial Intelligence (AI) on a computing device such as Computers, Mobile Devices, Programmable Logic Controller or Embedded Platforms. It will be apparent to a person skilled in the art that Artificial Intelligence relates to the computer science dealing with simulation of intelligent behavior in computers. It means using AI, computers are made to think like human beings. There are various intelligent agents or algorithms which are designed for such functionality.

Referring to FIG. 3, the method 100 starts at step 105. At this step 105, the method 100 or the virtual sensor is adapted to collect set of data from one or more sensing agents. The said set of data includes temperature, pressure, power factor, downtime, quality parameters, PH and the like. However, this should not be construed as a limitation for the method 100. There can be other parameters as well for the method 100. There are various sensing agents for sensing such data in real time processes or offline requirements. In an embodiment, the sensing agents are the physical agents such as a temperature sensor, a PH sensor, a Pressure sensor etc.

In another embodiment, the sensing agents are the virtual sensors for collecting and providing data where such collected set of data is used by the virtual sensors for measuring various parameters.

Once the data is collected, the method 100 flows to step 110. At step 110, it checks whether a processing of data is required on the collected data or not. For example, if there are 2 sensing units namely, Temperature sensor and Pressure sensor and the Flow is required to be predicted. In such a case, a processing Algorithm as Fourier Transform is used for predicting or determining the real time Flow parameter in order to be provided to the Virtual Sensor.

In an embodiment, if the processing is not required, then method 100 flows to step 120. At this step 120, the method 100 is adapted to create a Distributed Knowledge Database for storing the collected set of data.

In another embodiment, if the processing is required, then the method 100 flows to step 115. At this step 115, a processing of data is performed using various transformation techniques, such as Fourier transform. At step 120, the set of data is stored in the Distributed Knowledge Database.

Thereafter, the method 100 flows to step 125 where a parameter is determined from the set of data stored in the Distributed Knowledge Database. The parameter is any kind of parameter which is generally used in industries where control and automation systems are used. These parameters are temperature, pressure, power factor, downtime, quality parameters, PH and the like. However, this should not be construed as a limitation for the method 100. There can be other parameters as well for the method 100.

Such determining of the parameter at step 125 of the method 100 depends upon the use of the said parameter. For instance, if there is requirement for measuring and controlling the PH in a process, then a virtual sensor meant for determining the PH is used even when a physical PH sensor is not available.

In an embodiment, once the parameter is determined, it is used for control or automation process as described in step 130. The virtual sensor or the method 100 includes an intelligent agent who is capable of performing a specific function, be it controlling a parameter in a process or be it some kind of automation work. This however should not be construed to be a limitation of the method. Intelligent agents are typically methods which get the parameters from sensors and act upon an environment and directs towards achieving certain tasks.

In an embodiment of the present invention, the parameters determined by the virtual sensor are offline parameters.

In an embodiment of the present invention, the parameters are real time parameters.

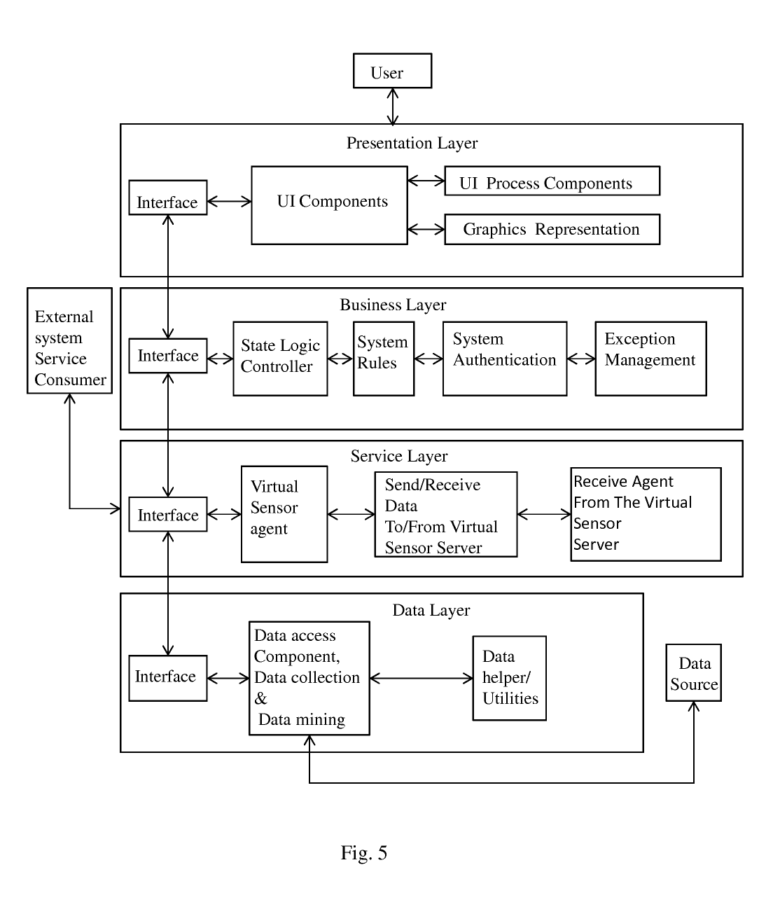

Now referring to FIG. 4, there is shown a Virtual Sensor Server accessible by the user through one or more sensing unit via communication network. The Virtual Sensor Server includes a presentation layer, business layer, a service layer and a data layer. Further, Virtual Sensor Server layers are configured with common interface for performing different functions. Further, the presentation layer includes user interface (UI) components, a user interface process components and graphics representation component configured with the common interface.

Further, the common interface allows a user to navigate Virtual Sensor Server. Further, the common interface allows a user to provide user input based on the user requirement. Further, the common interface is configured with business layer having a state logic controller, a system rules, a system authentication which is adapted to authenticate the user and user's one or more sensing unit and exception management for handling the exception occurring during the process.

Further, the common interface is configured with the service layer. The service layer includes an intelligent agent creator module for virtual sensor, a find best module for the user or shopper which adapted search and select the best intelligent agent based on the user requirement, an agent trainer which adapted to update the intelligent agent for new condition and situation by accessing the distributed knowledge database or one or more sensing unit, a send/receive data module which is adapted to send or receive data to/from one or more sensing unit/client, a module to send intelligent agent to the Virtual Sensor Client running on one or more sensing unit.

Furthermore, the common interface is configured with the data mining layer. The data mining layer includes a data access, mining and collection module for receiving the data from a data source and send to a data helper for pre-processing the data and stored in the data source.

Now referring to FIG. 5, there is shown a Virtual Sensor Client (VSC) running on the one or more sensing unit. The Virtual Sensor Client includes a presentation layer, business layer, a service layer and a data layer. Further, the presentation layer and the business layer are same as describes above in FIG. 4. Further, the service layer is adapted to receive an intelligent agent from the Virtual Sensor Server based on the user requirement. Further, the data layer is adapted to collect data and provides data access from the data source or distributed knowledge database. Further, the data layer includes data helper/utilities for arranging the data in a specific format.

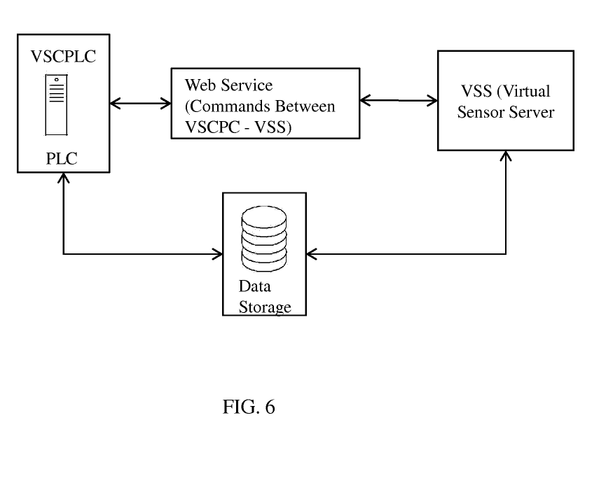

Now referring to FIGS. 6-11, the figures illustrate exemplary embodiment of a smart virtual sensor system for implementing the Virtual Sensor Client (VSC) on the PLC (programmable logic control) for virtually measuring or determining any type of parameter such as, Temperature, Pressure, Power Factor, Quality Parameters, etc. in any situation with or without physical sensor. Further, the virtual sensor system allows a Virtual Sensor Server to provide a graphical user interface which is accessible through the VSCPLC (Virtual Sensor Client (VSC) running on the PLC). Further, the smart virtual sensor system allows the PLC and VSS to communicate and exchange commands with each other. Further, the Virtual Sensor Server is adapted to generate an intelligent agent based on the VSCPLC hardware and user requirement. Further, Virtual Sensor Server (VSS) is adapted to update and train the intelligent agent based on the predefined schedule or events.

Further, the Virtual Sensor Server is adapted to transfer the intelligent agent to VSCPLC (the Virtual Sensor Client running on the PLC). Further, the Virtual Sensor Server includes a rules system to determine the action or events. Further, the virtual sensor is adapted to use data mining and data collection for collecting data from one or more Virtual Sensor Client (VSC) running on the one or more sensing unit and store the data in the data storage. Further, the Virtual Sensor Server is adapted to create a distributed knowledge database which contains action or events for one or more intelligent agent running on the one or more sensing unit.

In an embodiment, the VSCPLC (the Virtual Sensor Client running on the PLC) is adapted to communicate and share data with mobile devices, web application through web server, other computer, and one or more sensing unit via internet.

In one embodiment, the VSCPLC includes virtual sensor capability for providing the virtual sensor information to the Virtual Sensor Server for selecting the best intelligent agent. Further, the virtual sensor information is a type of virtual sensor which the user wants to create on the one or more sensing unit such as VSCPLC. For instance, if there is requirement for measuring and controlling the PH in a process, then a virtual sensor meant for determining the PH virtual sensor is used even when a physical PH sensor is not available.

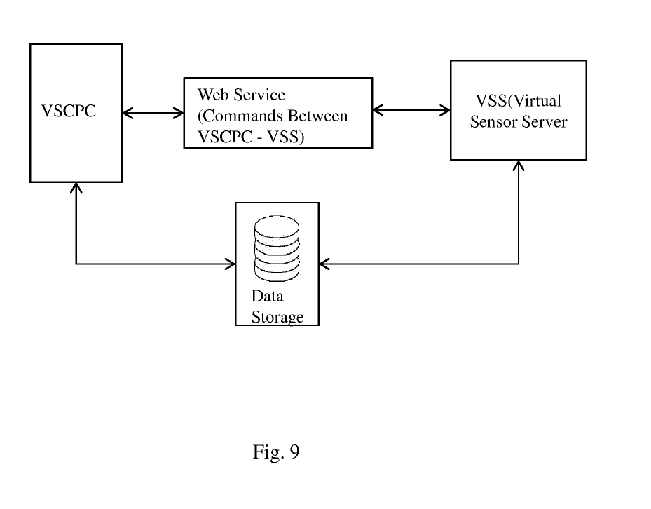

Now referring to FIG. 9, which illustrates a smart virtual sensor system implementing the Virtual Sensor Client (VSC) running on the personal computer (PC) for virtually measuring any type of parameter such as, Temperature, Pressure, Power Factor, Quality Parameters, etc. in any situation with or without the presence of a physical sensor. Further, the smart virtual sensor system allows a Virtual Sensor Server to provide a graphical user interface which is accessible through the VSCPC running on the personal computer (PC) by using web service.

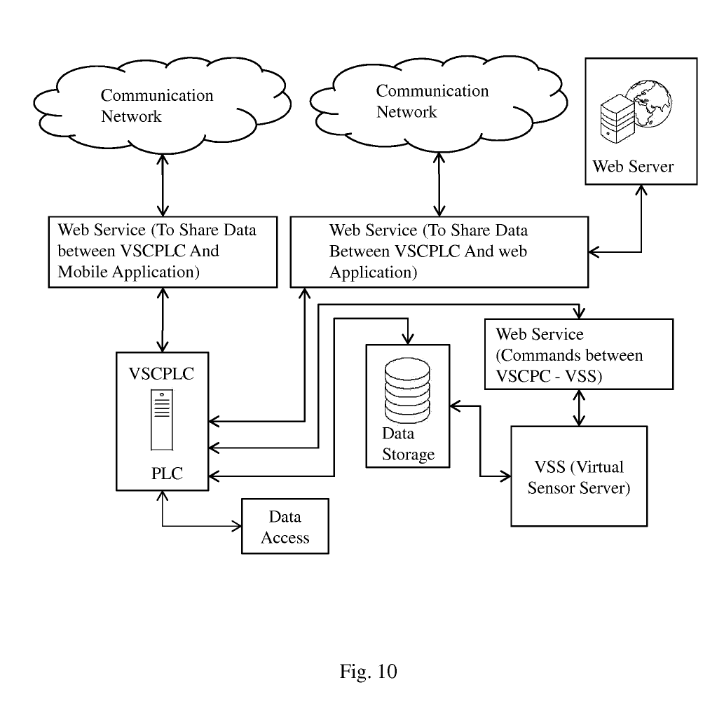

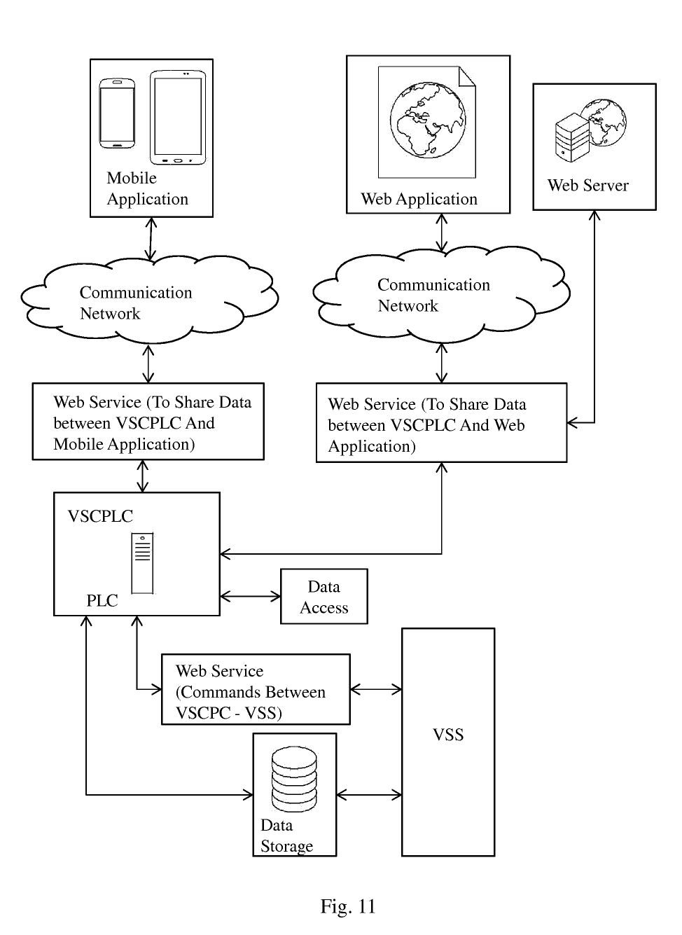

Referring to FIGS. 10-11, there is shown an exemplary smart virtual sensor system for measuring or determining parameters based upon collected set of data. In the FIG. 10, there is shown a VSC installed on a PLC and being capable of communicating with various other applications such as mobile application, web application etc. installed on other devices in the communication network. There is shown a web service meant for sharing data among the devices. The VSC installed on the PLC is capable of communicating with the Virtual Sensor Server for exchanging commands with each other.

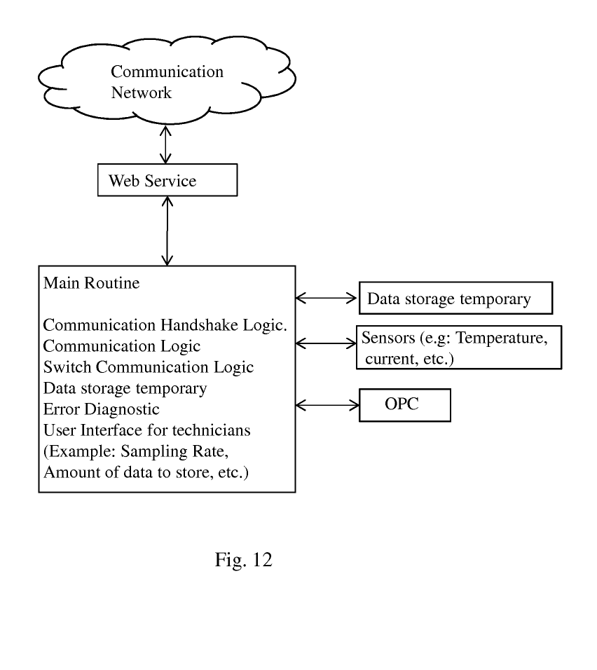

Referring to FIG. 12, there is shown an OPC, Open Platform Communications system. It will be apparent to a person skilled in the art that OPC is a software interface standard which allows the operating system programs to communicate with industrial hardware devices. Based upon client server architecture, a handshaking mechanism occurs between the Virtual Sensor Client and Virtual Sensor Server. The handshaking protocol allows the client and server to acknowledge each other and get ready for data exchange.

In an embodiment, the hardware is a physical sensor such as temperature sensor, etc.

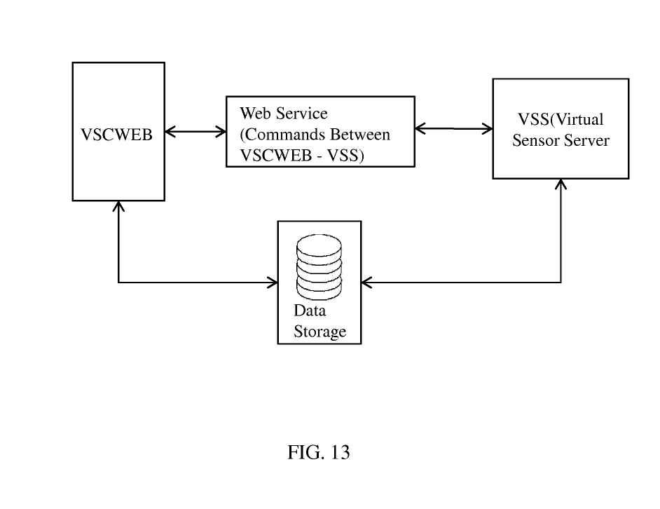

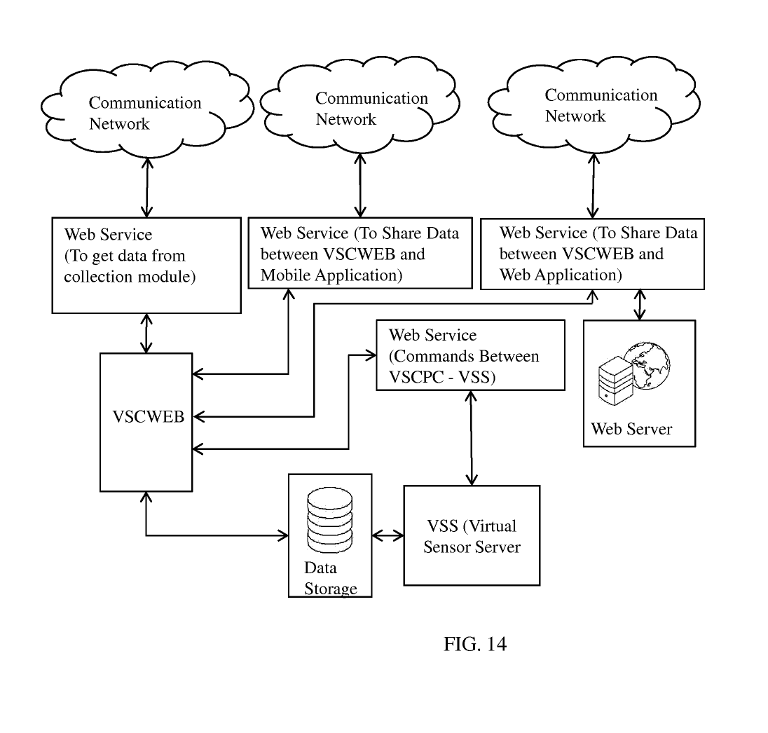

Referring to FIG. 13-14, there is shown a smart virtual sensor system implemented as a web service. The Virtual Sensor Client is adapted to be used as a web service. A user (not shown) may access the web service using a web browser such as internet explorer, google chrome, etc. The Virtual Sensor Client named VSCWEB communicates with the Virtual Sensor Server for exchange of commands among each other. The user may access the VSCWEB using any kind of computing device having the capability of accessing the internet. The computing device includes a computer, mobile device, etc. However, this should not be construed as a limitation to the present invention.

In an embodiment, the smart virtual sensor system includes a data collection module. The said data collection module is meant for collecting data from the one or more sensing units in the communication network. The data collection module is adapted to collect and store data in the distributed knowledge database. The data so collected can be a real time data or offline available data from one or more sensing units.

In an embodiment, the one or more sensing units are physical sensors such as temperature sensor, pressure sensor, etc.

In an embodiment, the one or more sensing unit is a virtual sensor.

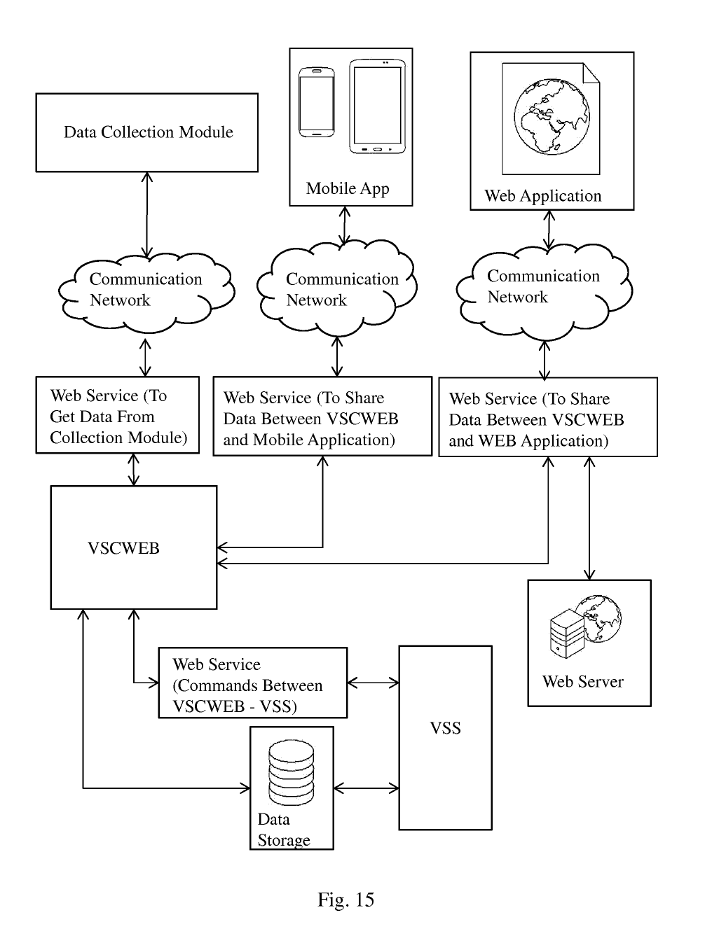

Referring to FIG. 15, there is shown a layout of the distributed architecture where a Virtual Sensor Client is provided on the web. The said Virtual Sensor Client contains a data collection module which is adapted to collect data from various sensing units in the communication network. The Virtual Sensor Client on the web is further adapted to share data with a mobile application. There is shown a VSS which stands for Virtual Sensor Server which exchanges commands with the Virtual Sensor Client on the web.

The present invention finds wide applicability in areas where control/automation processes are required. Further, the smart and intelligent virtual sensor is capable of sensing and measuring data even when there is no physical sensor provided.

The system, as described in the disclosed teachings or any of its components, may be embodied in the form of a computer system. Typical examples of a computer system include a general-purpose computer, a PDA, a cell phone, a programmed microprocessor, a micro-controller, a peripheral integrated circuit element, and other devices or arrangements of devices that are capable of implementing the steps that constitute the method of the disclosed teachings.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer.

In a computer system comprising a general-purpose computer, such may include an input device, and a display unit. Specifically, the computer may comprise a microprocessor, where the microprocessor is connected to a communication bus. The computer may also include a memory. The memory may include Random Access Memory (RAM) and Read Only Memory (ROM). The computer system further comprises a storage device, which can be a hard disk drive or a removable storage drive such as a floppy disk drive, optical disk drive, and the like. The storage device can also comprise other, similar means for loading computer programs or other instructions into the computer system.

The computer system may comprise a communication device to communicate with a remote computer through a network. The communication device can be a wireless communication port, a data cable connecting the computer system with the network, and the like. The network can be a Local Area Network (LAN) or a Wide Area Network (WAN) such as the Internet and the like. The remote computer that is connected to the network can be a general-purpose computer, a server, a PDA, and the like. Further, the computer system can access information from the remote computer through the network.

It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatus configured to implement the method are within the scope of the present invention.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present invention.

What is claimed is:

1. A computer implemented method for developing a virtual sensor for determining a real time or offline parameter from a set of data, wherein the parameter is used for performing a specific function in a distributed network, the computer implemented method comprising,
collecting the set of data from one or more sensing unit in the distributed network;
processing the collected set of data;
creating a distributed knowledge database containing the processed set of data, wherein the distributed knowledge database is shared over the distributed network;
determining the parameter based upon the processed set of data in the distributed knowledge database; and
performing a specific function using the parameter,
wherein the virtual sensor selects at least one intelligent agent for performing the specific function in the distributed network.

2. The computer implemented method as claimed in claim 1, wherein the virtual sensor comprises a hardware platform module for determining structure of the one or more sensing units.

3. The computer implemented method as claimed in claim 1, wherein the virtual sensor comprises a retrain module for updating the virtual sensor with new data from the one or more sensing units.

4. The computer implemented method as claimed in claim 1, wherein the specific function comprises at least one of control function, and automation function.

5. The computer implemented method as claimed in claim 1, wherein the set of data comprises data comprising temperature, pressure, power factor, downtime, quality parameters, and PH.

6. The computer implemented method as claimed in claim 1, wherein the one or more sensing unit is a physical sensor.

7. The computer implemented method as claimed in claim 1, wherein the one or more sensing unit is a virtual sensor.

8. The computer implemented method as claimed in claim 1, wherein the distributed knowledge database is stored on a server.

9. A system for determining a real time or offline parameter from a set of data, wherein the parameter is used for performing a specific function in a distributed network, the system comprising:
one or more processors;
a memory comprising a virtual sensor and executable by the one or more processors to perform the steps of—
collecting the set of data from one or more sensing unit in the distributed network;
processing the collected set of data;
creating a distributed knowledge database containing the processed set of data wherein the distributed knowledge database is shared over the distributed network;
determining the parameter based upon the processed set of data in the distributed knowledge database; and
performing a specific function using the parameter,
wherein the virtual sensor selects at least one intelligent agent for performing the specific function in the distributed network.

10. The system as claimed in claim 9, wherein the virtual sensor comprises a hardware platform module for determining structure of the one or more sensing units.

11. The system as claimed in claim 9, wherein the virtual sensor comprises a retrain module for updating the virtual sensor with new data from the one or more sensing units.

12. The system as claimed in claim 9, wherein the specific function comprises at least one of control function, and automation function.

13. The system as claimed in claim 9, wherein the set of data comprises data such as temperature, pressure, power factor, downtime, quality parameters, and PH.

14. The system as claimed in claim 9, wherein the one or more sensing unit is a physical sensor.

15. The system as claimed in claim 9, wherein the one or more sensing unit is a virtual sensor.

16. The system as claimed in claim 9, wherein the distributed knowledge database is stored on a server.

17. A computer program product computer program product comprising executable instructions which, when executed by one or more processors, cause the one or more processors to carry out the steps of:
collecting the set of data from one or more sensing unit in the distributed network;
processing the collected set of data;
creating a distributed knowledge database containing the processed set of data, wherein the distributed knowledge database is shared over the distributed network;
determining the parameter based upon the processed set of data in the distributed knowledge database; and
performing a specific function using the parameter,
wherein the virtual sensor selects at least one intelligent agent for performing the specific function in the distributed network.
